(19) United States
(12) Patent Application Publication
(10) Pub. No.: US 2008/0243570 A1
(43) Pub. Date: Oct. 2, 2008

(54) Time-Based Decomposition for Optimization of Master Planning Problems

(76) Inventors: Jayan Moorkanat, Marathahalli (IN); Jayakumar Nandakumar, Vimanapura Post (IN); Anindya Banerjee, Cambridge, MA (US)

Correspondence Address: i2 TECHNOLOGIES US, INC., ONE i2 PLACE, 11701 LUNA ROAD, DALLAS, TX, 75234, US

(21) Appl. No.: 12/021,103

(22) Filed: Jan. 28, 2008

Related U.S. Application Data
(60) Provisional application No. 60/908,218, filed on Mar. 27, 2007.

(51) Int. Cl. G06Q 10/00

(52) U.S. Cl. 705/7

(57) ABSTRACT

A system and method is disclosed for optimization of master planning problems. The system provides for accessing supply chain data describing the flow of one or more items through the supply chain network and accessing constraints and a planning problem associated with one or more entities associated with the supply chain network. The system further provides for modeling a planning problem for a planning horizon based on at least a portion of the accessed supply chain data and the constraints. The system still further provides for decomposing the planning horizon into multiple sub-horizons and optimizing the planning problem for each of the multiple sub-horizons. The system yet further provides for generating an optimal supply chain plan for the planning problem, based on the optimization of the multiple sub-horizons.

### CROSS-REFERENCE TO RELATED APPLICATIONS

The present invention is related to that disclosed in U.S. Provisional Patent Application Ser. No. 60/908,218, filed 27 Mar. 2007, entitled “SLIDING TIME WINDOWS AND TIME-BASED DECOMPOSITION TO SOLVE SUPPLY CHAIN MASTER PLANNING PROBLEMS”. U.S. Provisional Patent Application Ser. No. 60/908,218 is assigned to the assignee of the present application. The subject matter disclosed in U.S. Provisional Patent Application Ser. No. 60/908,218 is hereby incorporated by reference into the present disclosure as if fully set forth herein. The present invention hereby claims priority under 35 U.S.C. §119(e) to U.S. Provisional Patent Application Ser. No. 60/908,218.

### TECHNICAL FIELD OF THE INVENTION

The present invention relates generally to the field of time-based decomposition and, more specifically, to a system and method for optimization of master planning problems.

### BACKGROUND OF THE INVENTION

A supply chain plan describes items to be procured and operations to be performed by entities within a supply chain network in order to deliver materials or products to an entity, such as, for example, a customer within the supply chain network. Various constraints may be placed on the supply chain network, such as, for example, limitations on the availability of materials or products from one of the entities within the supply chain network. However, due to these various constraints, one or more of these entities within the supply chain network may not be able to satisfy all of the supply chain demand. The inability to satisfy all of the supply chain demand within the supply chain network is undesirable.

In an effort to satisfy supply chain demand, prior art entities within the supply chain network have tried to optimize this supply chain planning problem, also referred to as a master planning problem, associated with these various constraints. However, this optimization has proved disadvantageous since, for example, the planning problem size and complexity on the datasets associated with each of the entities within the supply chain network is quite large. Consequently, as the size of a planning problem grows, the computational power and time required to solve the master planning problem also increases. This increase in computational power and time required to solve the master planning problem is undesirable.

### SUMMARY OF THE INVENTION

A system for optimization of master planning problems is disclosed. The system provides for accessing supply chain data describing the flow of one or more items through the supply chain network and accessing constraints and a planning problem associated with one or more entities associated with the supply chain network. The system further provides for modeling a planning problem for a planning horizon based on at least a portion of the accessed supply chain data and the constraints. The system still further provides for decomposing the planning horizon into multiple sub-horizons and optimizing the planning problem for each of the multiple sub-horizons. The system yet further provides for generating an optimal supply chain plan for the planning problem, based on the optimization of the multiple sub-horizons.

A method for optimization of master planning problems is also disclosed. The method provides for accessing supply chain data describing the flow of one or more items through the supply chain network and accessing constraints and a planning problem associated with one or more entities. The method further provides for modeling a planning problem for a planning horizon based on at least a portion of the accessed supply chain data and the constraints. The method still further provides for decomposing the planning horizon into multiple sub-horizons and optimizing the planning problem for each of the multiple sub-horizons. The method yet further provides for generating an optimal supply chain plan for the planning problem, based on the optimization of the multiple sub-horizons.

Software for optimization of master planning problems is also disclosed. The software provides for accessing supply chain data describing the flow of one or more items through the supply chain network and accessing constraints and a planning problem associated with one or more entities. The software further provides for modeling a planning problem for a planning horizon based on at least a portion of the accessed supply chain data and the constraints. The software still further provides for decomposing the planning horizon into multiple sub-horizons and optimizing the planning problem for each of the multiple sub-horizons. The software yet further provides for generating an optimal supply chain plan for the planning problem, based on the optimization of the multiple sub-horizons.

### BRIEF DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 illustrates an exemplary supply chain network according to a preferred embodiment;

FIG. 2 illustrates the supply chain planner of FIG. 1 in greater detail in accordance with the preferred embodiment;

FIGS. 3A through 3C illustrate exemplary planning horizons according to one embodiment; and

FIG. 4 illustrates an exemplary method for optimization of master planning problems.

### DETAILED DESCRIPTION OF THE INVENTION

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

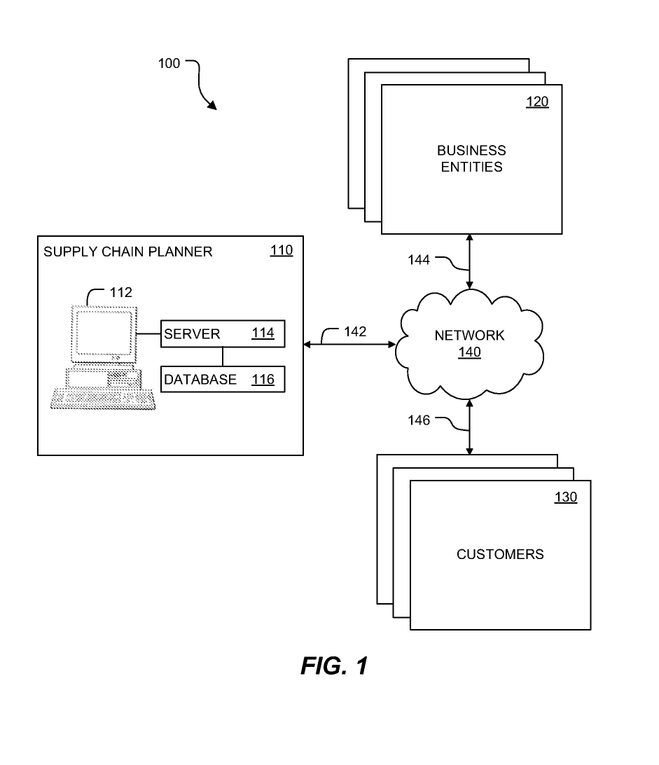

FIG. 1 illustrates an exemplary supply chain network 100 according to a preferred embodiment. Supply chain network 100 comprises a supply chain planner 110, one or more business entities 120, one or more customers 130, a network 140, and communication links 142, 144, and 146. Although, a single supply chain planner 110, one or more business entities 120, and one or more customers 130 are shown and described, embodiments contemplate any number of supply chain planners 110, any number of business entities 120, or any number of customers 130, according to particular needs.

Supply chain planner 110 comprises one or more computers 112, a server 114, and a database 116. In one embodiment, supply chain planner 110, and in particular, server 114, stores supply chain data and various constraints associated with one or more business entities 120 and one or more customers 130, in database 116. In another embodiment, one or more business entities 120 may be any suitable entity that manufactures or otherwise provides items to another entity within supply chain network 100. For example, one or more business entities 120 may include manufactures, manufacturing plants, distribution centers, work-centers or any other entity or enterprise related to an entity within supply chain network 100. In addition, although entities are primarily described as business entities, embodiments contemplate any other type of entities, such as, for example, resources including but not limited to services, labor, or the like. In another embodiment, one or more customers 130 may include any appropriate entity that purchases or otherwise receives an item, product, or a resource from one or more business entities 120.

In a preferred embodiment, supply chain network 100 may describe the flow of items, such as, for example, materials and products through one or more business entities 120, one or more customers 130, or any other supply chain planning environments associated with supply chain network 100. As described below, supply chain network 100 may be used to determine an optimal supply chain plan that manages items to be procured and operations to be performed in order to deliver material or products to one or more customers 130 and/or one or more business entities 120, in, for example, a particular planning horizon.

In one embodiment, supply chain network 100 may consider various constraints associated with one or more business entities 120 and/or one or more customers 130 when determining an optimal supply chain plan. Such constraints may include, for example, limitations on the availability of materials, the capacity of one or more business entities 120 and/or one or more customers 130, and the like. As described below in more detail, these various constraints may prevent one or more business entities 120 from satisfying a demand within supply chain network 100, and may delay this demand from being satisfied during a particular planning horizon. In addition, or as an alternative, the optimal supply chain plan may evaluate and select various optimal solutions based on the objectives of one or more business entities 120 and/or one or more customers 130. These objectives may include, but are not limited to, maximizing demand satisfaction, minimizing inventory, and maximizing use of preferred alternatives.

In addition, these various optimal solutions are associated with a master planning problem of supply chain network 100, and may include an optimal supply chain plan represented by a set of operations to be performed across a particular planning horizon. Although, supply chain network 100 is shown and described as associated with one or more business entities 120 and one or more customers 130, supply chain network 100 may provide an optimal supply chain plan to any number of entities, in any number of locations, according to particular needs.

In an embodiment, supply chain network 100 may operate on one or more computers that are integral to or separate from the hardware and/or software that support supply chain planner 110, one or more business entities 120, one or more customers 130, and/or network 140. Each of these one or more computers may include any suitable input device, such as a keypad, mouse, touch screen, microphone, or other device to input information. In addition, each of these one or more computers may include any suitable output device which may convey information associated with the operation of supply chain network 100, including digital or analog data, visual information, or audio information.

In addition, or as an alternative, each of these one or more computers may include fixed or removable storage media, such as magnetic computer disks, CD-ROM, wireless ports and connections, or other suitable media to receive output from and provide input to supply chain network 100. Furthermore, each of these one or more computers may include one or more processors and associated memory to execute instructions and manipulate information according to the operation of supply chain network 100.

In addition, although a single computer 112 is shown in FIG. 1, as being associated with supply chain planner 110, embodiments contemplate supply chain planner 110, one or more business entities 120, and one or more customers 130 each operating on one or more separate computers or each operating on one or more shared computers. Each of these one or more computers, may be, for example, a work station, personal computer (PC), network computer, notebook computer, personal digital assistant (PDA), cell phone, telephone, wireless data port, or any other suitable computing device.

In another embodiment, although supply chain planner 110, one or more business entities 120, and one or more customers 130 are shown and described as being separate from each other, embodiments contemplate combining supply chain planner 110, one or more business entities 120, and one or more customers 130, according to particular needs. For example, one or more business entities 120 and/or one or more customers 130 may be entities within a single enterprise, one or more business entities 120 and/or supply chain planner 110 may be entities within a single enterprise, or one or more customers 130 and/or supply chain planner 110 may be entities within a single enterprise.

In addition, or as an alternative, although supply chain network 100 is shown and described as including supply chain planner 110, one or more business entities 120, and one or more customers 130, embodiments further contemplate supply chain network 100 excluding one or more of supply chain planner 110, one or more business entities 120, and one or more customers 130, according to particular needs. For example, supply chain network 100 may exclude one or more business entities 120 and/or one or more customers 130, according to particular needs.

In one embodiment, supply chain planner 110 is coupled with network 140 using communications link 142, which may be any wireline, wireless, or any other link suitable to support data communications between supply chain planner 110 and network 140 during operation of supply chain network 100. One or more business entities 120 is coupled with network 140 using a communications link 144, which may be any wireline, wireless, or any other link suitable to support data communications between one or more business entities 120 and network 140 during operation of supply chain network 100. One or more customers 130 are coupled with network 140 using communications link 146, which may be any wireline, wireless, or any other link suitable to support data communications between one or more customers 130 and network 140 during operation of supply chain network 100.

Although communication links 142, 144, and 146 are shown as generally coupling supply chain planner 110, one or more business entities 120, and one or more customers 130 with network 140, supply chain planner 110, one or more business entities 120, and one or more customers 130 may communicate directly with supply chain planner 110, one or more business entities 120, and one or more customers 130, according to particular needs.

In another embodiment, network 140 includes the Internet and any appropriate local area networks (LANs), metropolitan area networks (MANS), or wide area networks (WANs) coupling supply chain planner 110, one or more business entities 120, and one or more customers 130. For example, data may be maintained by one or more business entities 120 at one or more locations external to supply chain planner 110 and/or one or more customers 130 and made available to one or more associated users of one or more business entities 120 and/or one or more customers 130 using network 140 or in any other appropriate manner. Those skilled in the art will recognize that the complete structure and operation of communication network 140 and other components within supply chain network 100 are not depicted or described. Embodiments may be employed in conjunction with known communications networks and other components.

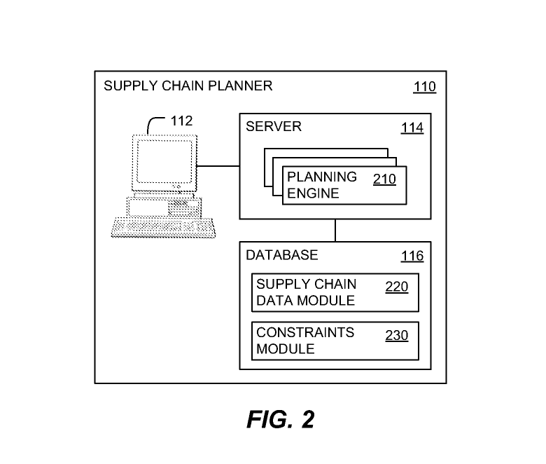

FIG. 2 illustrates supply chain planner 110 of FIG. 1 in greater detail in accordance with the preferred embodiment. As discussed above, supply chain planner 110, and in particular, server 114, stores supply chain data and various constraints associated with one or more business entities 120 and/or one or more customers 130, in database 220. In addition, as discussed above, supply chain planner 110 comprises one or more computers 112 at one or more locations including associated input devices, output devices, mass storage media, processors, memory, or other components for receiving, processing, storing, and communicating information according to the operation of supply chain network 100.

In one embodiment, server 114 generates an optimal supply chain plan for items to be procured and operations to be performed in order to deliver material or products to one or more business entities 120 and/or one or more customers 130, in, for example, a particular planning horizon. As discussed in more detail below, server 114 comprises one or more planning engines 210 for generating an optimal supply chain plan of a master planning problem associated with supply chain network 100.

In an embodiment, one or more planning engines 210 may be heuristic in nature or based on optimization techniques. As an example only, and not by way of limitation, one or more planning engines 210 may be based on optimization techniques and may be a linear programming based optimization engine, wherein the linear programming based optimization engine uses a linear programming technique to solve various constraints associated with, or applied to, one or more business entities 120 and/or one or more customers 130. In addition, although server 114 is shown and described as comprising one or more planning engines 210, embodiments contemplate any suitable engine or combination of engines, according to particular needs.

Database 116 comprises one or more databases or other data storage arrangements at one or more locations, local to, or remote from, server 114. Database 116 may include, for example, supply chain data module 220 and constraints module 230. Database 116 stores supply chain data associated with one or more business entities 120 and/or one or more customers 130 into supply chain data module 220, that may be used by server 210, and in particular, by one or more planning engines 210. Data associated with supply chain data module 220 may be, for example, data that describes the flow of items such as materials and/or products through one or more business entities 120 and/or one or more customers 130.

In addition, constraints stored in constraints module 230 may be constraints that are associated with, or applied to, one or more business entities 120 and/or one or more customers 130, and may prevent one or more business entities 120 from satisfying supply chain demand, in, for example, a particular planning horizon. Constraints stored in constraints module 230 may include, but are not limited to: lead-time constraints that describe the time required for one or more business entities 120 to supply items to one or more customers 130 and/or one or more other business entities 120; lot size constraints that define a quantity of items that may be transferred to, or from, one or more business entities 120 and/or one or more customers 130; and/or capacity constraints that describe a maximum quantity of items that may be produced, or stored, at one or more business entities 120 and/or one or more customers 130. Although, constraints have been described as particular constraints, embodiments contemplate any constraint or combination of constraints that may prevent one or more business entities 120 from satisfying supply chain demand.

To further explain the operation of supply chain planner 110, an example is now given. In the following example, server 114 models a master planning problem associated with supply chain network 100. That is, one or more planning engines 210 represents one or more business entities 120 and/or one or more customers 130 related to the master planning problem, in terms of software entities. In addition, or as an alternative, server 114 models the constraints associated with one or more business entities 120 and/or one or more customers 130, wherein the constraints are modeled to represent the flow of items through supply chain network 100. In addition, supply chain network 100, including the constraints associated with one or more business entities 120 and/or one or more customers 130 are valid for a particular period of interest, i.e., a planning horizon.

In one embodiment, one or more planning engines 210 decomposes the planning horizon associated with the master planning problem into multiple sub-horizons. As described in more detail below, one or more planning engines 210 solves each of the multiple sub-horizons of the planning horizon, such that, the optimization of a prior sub-horizon does not adversely affect the time required for optimization of a subsequent sub-horizon. That is, one or more planning engines 210 takes into account the netted information associated with the optimization of a prior sub-horizon and the absolute information associated with the optimization of a subsequent sub-horizon. In addition, once each of the multiple sub-horizons are optimized, one or more planning engines 210 generates an optimal supply chain plan, based on the optimization results of the multiple sub-horizons.

Thus in accordance with the principles of embodiments, supply chain planner 110 decomposes the planning horizon into multiple sub-horizons and solves each sub-horizon, such that the sum of each optimized sub-horizons is optimized into an optimal supply chain plan for the particular planning horizon. Among other things, this reduces the complexity of the master planning problem and minimizes the number of iterations required to solve the master planning problem, which enables embodiments to reduce the time required to solve the master planning problem, for a particular planning horizon.

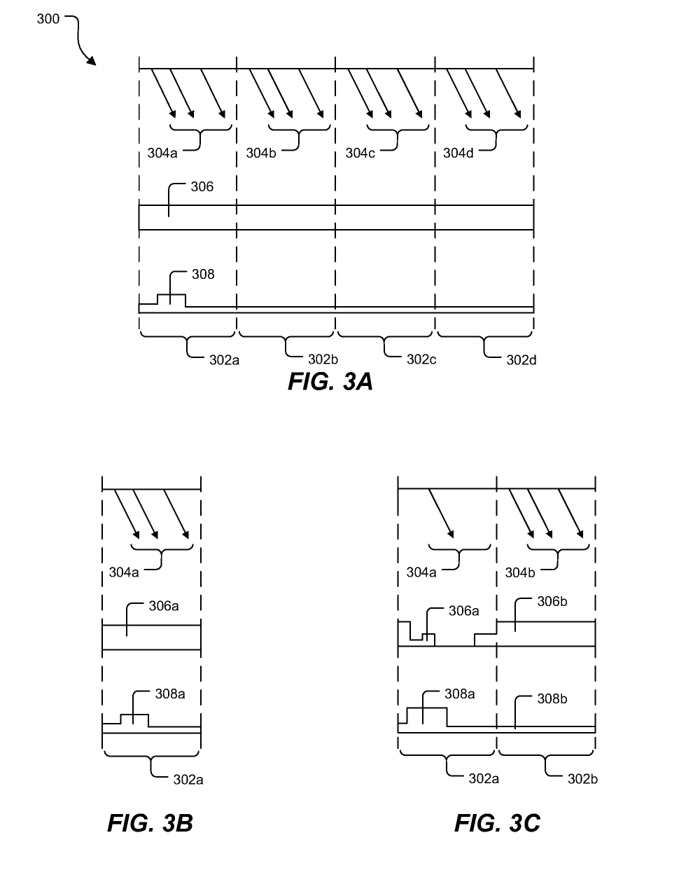

FIGS. 3A through 3C illustrate exemplary planning horizons according to one embodiment. As discussed above, supply chain planner 110 generates an optimal supply chain plan for items to be procured and operations to be performed in order to deliver material or products to one or more business entities 120 and/or one or more customers 130, in, for example, a particular planning horizon. Although particular values are shown and described with FIGS. 3A through 3C, embodiments contemplate any suitable value or values may be used without departing from the scope of the present invention. In addition, planning horizon 300 may represent a demand associated with one or more business entities 120, one or more customers 130, a group of one or more business entities 120 and one or more customers 130, and/or all of the one or more business entities 120 and the one or more customers 130.

FIG. 3A illustrates an exemplary planning horizon 300, according to one embodiment. Planning horizon 300 represents some period of time during which one or more business entities 120 may provide one or more items to another entity within supply chain network 100. In one embodiment, server 114 and in particular, one or more planning engines 210 utilize a time-based decomposition to decompose the planning horizon into multiple sub-horizons 302a-d, i.e., windows of time, wherein each sub-horizon 302a-d includes a granularity of time buckets. Sub-horizons 302a-d and the associated time buckets may be associated with any suitable length of time, such as, for example, hours in a day, days in a week, weeks in a month, months in a year, or the like.

Demands 304a-d represent the demand associated with one or more business entities 120 and/or one or more customers 130 for an item manufactured by, or otherwise provided by, one or more business entities 120. In addition, or as an alternative, one or more planning engines 210 may optimize the planning problem utilizing resources 306 and materials 308, such that, resources 306 and materials 308 are also decomposed into multiple sub-horizons 302a-d.

To further explain the operation of the time-based decomposition of a planning horizon, an example is now given. In the following example, supply chain planner 110 optimizes a planning problem for a one-year planning horizon. In addition, the one-year planning horizon includes a 52-week granularity, that is, the one-year planning horizon includes 52 weekly time buckets. Server 114 and in particular, one or more planning engines 210 decompose the one-year planning horizon into four sub-horizons 302a-d, that is, four windows of time each including 13 weekly time buckets. Although, the planning horizon, sub-horizon, and the time buckets are shown and described as comprising a particular period of time, embodiments contemplate any suitable period of time or combination of times, according to particular needs.

FIG. 3B illustrates a planning problem optimization performed on sub-horizon 302a. Continuing with the example of FIG. 3A, one or more planning engines 210 optimizes the planning problem for the first window of time, i.e., sub-horizon 302a. In addition, resources 306a and materials 308a are optimized for sub-horizon 302a, to the extent, that is desired in the form of, for example, demand 304a, safety stock requirements, and the like. As discussed above, one or more planning engines 210 may be based on optimization techniques and may be a linear programming based optimization engine, wherein the linear programming based optimization engine uses a linear programming technique to solve various constraints associated with, or applied to, one or more business entities 120 and/or one or more customers 130.

FIG. 3C illustrates a planning problem optimization performed on sub-horizon 302b, including any netted information associated with optimized sub-horizon 302a. Continuing with the example of FIG. 3B, one or more planning engines 210 truncates any netted information associated with demand 304a, capacity 306a, and material 308a of sub-horizon 302a. For example, the truncation may take into account any demand 304a that has already been planned for in sub-horizon 302a, any capacity 306a and any material 308a that have already been utilized in sub-horizon 302a. In addition, one or more planning engines 210 optimizes the planning problem for the second window of time, i.e., sub-horizon 302b including resources 306b and materials 308b. As described above, one or more planning engines 210 takes into account the netted information associated with optimized sub-horizon 302a and the absolute information associated with sub-horizon 302b.

In addition, one or more planning engines 210 optimizes the planning problem for the third and forth window of time, i.e., sub-horizons 302c and 302d, similar to the optimization performed with respect to sub-horizons 302a and 302b. Once all sub-horizons 302a-d are optimized, one or more planning engines 210 generates an optimal supply chain plan, based on the sum of each optimized sub-horizons 302a-d. For example, one or more planning engines may run a “dummy” optimization to combine or otherwise sum all of the sub-horizon optimization information. Although, the generation of the optimal supply chain plan is described in a particular manner, embodiments contemplate combining or otherwise aggregating each of the optimized sub-horizons 302a-d, according to particular needs.

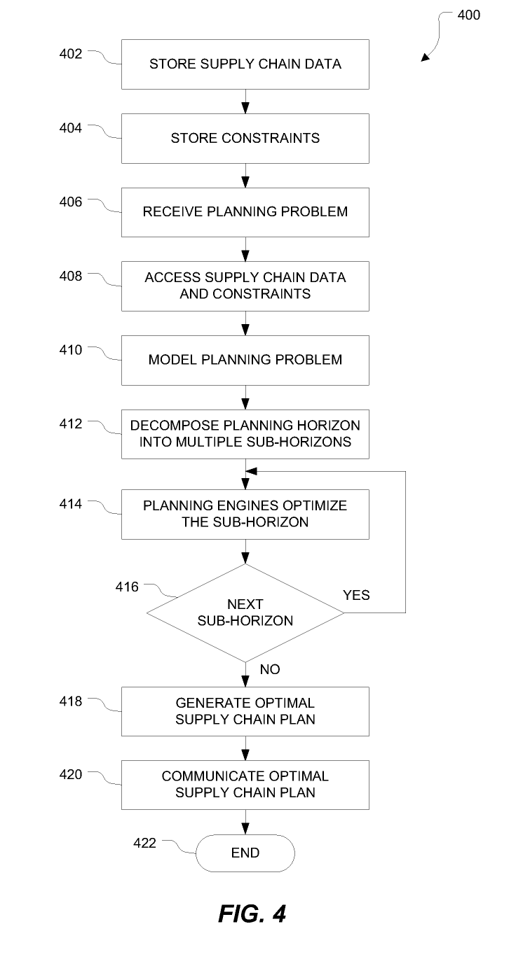

FIG. 4 illustrates an exemplary method 400 for optimization of master planning problems. As discussed above, supply chain planner 110 generates an optimal supply chain plan of a master planning problem, based on the optimization of multiple sub-horizons associated with supply chain network 100. The method begins at step 402, where one or more business entities 120 and/or one or more customers 130 store supply chain data into database 116 and in particular, supply chain data module 220. As discussed above, data stored into supply chain data module 220 describes the flow of items, such as materials and/or products through supply chain network 100. At step 404, one or more business entities 120 and/or one or more customers 130 store constraints associated with, or applied to, one or more business entities 120 and/or one or more customers 130 into database 116 and in particular, constraints module 230.

At step 406, server 114 receives a planning problem from one or more business entities 120 and/or one or more customers 130. In addition, or as an alternative, server 114 may access a planning problem previously stored in database 116, by one or more business entities 120 and/or one or more customers 130. At step 408, server 114 accesses supply chain data module 220 and constraints module 230.

At step 410, server 114 models the planning problem associated with supply chain network 100. As discussed above, one or more planning engines 210 represents one or more business entities 120 and/or one or more customers 130 related to the planning problem, in terms of software entities. At step 412, server 114 and in particular, one or more planning engines 210 utilize a time-based decomposition to decompose the planning horizon into multiple sub-horizons.

At step 414, one or more planning engines 210 solve each of the decomposed sub-horizons, such that, the optimization of a prior sub-horizon does not adversely affect the time required to optimize a subsequent sub-horizon. In addition, as discussed above, one or more planning engines 210 may take into account the netted information associated with an optimized prior sub-horizon and the absolute information associated with a subsequent sub-horizon. As an example only and not by way of limitation, one or more planning engines 210 may use a column generation technique to solve each of the decomposed sub-horizons. In this manner, one or more planning engines 210 generates columns using the solution of the decomposed sub-horizon, which may be modeled as, for example, a shortest path problem generated by relaxing certain constraints associated with one or more business entities 120 and/or one or more customers 130. Although, a column generation technique is described with one or more planning engines 210, embodiments contemplate any suitable technique or combination of techniques, according to particular needs.

At step 416, server 114 determines whether there is a next sub-horizon. If there is a next sub-horizon, server 114 returns to step 414 to select the next sub-horizon and perform a sequential run of the one or more planning engines. If there is no next sub-horizon, the method proceeds to step 418 to generate an optimal supply chain plan, based on the optimization of the sub-horizons. As discussed above, after solving each of the sub-horizon, server 114 sums each of the optimized sub-horizons into an optimal supply chain plan for the particular planning horizon.

At step 420, the optimal supply chain plan in communicated to one or more business entities 120 and/or one or more customers 130, according to particular needs. The optimal supply chain plan enables one or more supply chain entities to satisfy all of the supply chain demand within supply chain network 100, in a particular planning horizon. Once the supply chain plan has been optimized and communicated to one or more business entities 120 and/or one or more customers 130, the method ends at step 422. In addition, although, FIG. 4 illustrates one embodiment of a method for optimization of master planning problems, various changes may be made to method 400 without departing from the scope of the present invention.

Reference in the foregoing specification to “one embodiment”, “an embodiment”, or “another embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. A system for optimizing master planning problems associated with a supply chain network, comprising a server associated with one or more software components collectively operable to:
access supply chain data describing the flow of one or more items through the supply chain network;
access constraints associated with one or more entities;
access a planning problem associated with the one or more entities;
model the planning problem for a planning horizon based on at least a portion of the accessed supply chain data and the constraints;
decompose the planning horizon into multiple sub-horizons;
optimize the planning problem for each of the multiple sub-horizons; and
generate an optimal supply chain plan for the planning problem, based on the optimization of the multiple sub-horizons.

2. The system of claim 1, wherein the supply chain data is stored in one or more databases by the one or more entities associated with the supply chain network.

3. The system of claim 1, wherein the constraints are stored in one or more databases by the one or more entities associated with the supply chain network.

4. The system of claim 1, wherein the planning problem is stored in one or more databases by the one or more entities associated with the supply chain network.

5. The system of claim 1, wherein decomposing the planning horizon comprises dividing the planning horizon into windows of time based on a time-based decomposition technique.

6. The system of claim 1, wherein the multiple sub-horizons comprise multiple time buckets.

7. The system of claim 1, wherein the one or more entities are entities selected from the group consisting of one or more manufactures, one or more manufacturing plants, one or more distribution centers, one or more work-centers, and one or more customers.

8. The system of claim 1, further operable to:
communicate the optimal supply chain plan to the one or more entities associated with the supply chain network.

9. The system of claim 1, wherein a column generation technique is used to optimize the planning problem for each of the multiple sub-horizons.

10. A method for optimizing master planning problems associated with a supply chain network, the method comprising:
accessing supply chain data describing the flow of one or more items through the supply chain network;
accessing constraints associated with one or more entities;
accessing a planning problem associated with the one or more entities;
modeling the planning problem for a planning horizon based on at least a portion of the accessed supply chain data and the constraints;
decomposing the planning horizon into multiple sub-horizons;
optimizing the planning problem for each of the multiple sub-horizons; and
generating an optimal supply chain plan for the planning problem, based on the optimization of the multiple sub-horizons.

11. The method of claim 10, wherein the supply chain data is stored in one or more databases by the one or more entities associated with the supply chain network.

12. The method of claim 10, wherein the constraints are stored in one or more databases by the one or more entities associated with the supply chain network.

13. The method of claim 10, wherein the planning problem is stored in one or more databases by the one or more entities associated with the supply chain network.

14. The method of claim 10, wherein decomposing the planning horizon comprises dividing the planning horizon into windows of time based on a time-based decomposition technique.

15. The method of claim 10, wherein the multiple sub-horizons comprise multiple time buckets.

16. The method of claim 10, wherein the one or more entities are entities selected from the group consisting of one or more manufactures, one or more manufacturing plants, one or more distribution centers, one or more work-centers, and one or more customers.

17. The method of claim 10, further comprising:
communicating the optimal supply chain plan to the one or more entities associated with the supply chain network.

18. The method of claim 10, wherein a column generation technique is used to optimize the planning problem for each of the multiple sub-horizons.

19. Software for optimizing master planning problems associated with a supply chain network, the software embodied in a computer-readable medium and, when executed, operable to:
access supply chain data describing the flow of one or more items through the supply chain network;
access constraints associated with one or more entities;
access a planning problem associated with the one or more entities;
model the planning problem for a planning horizon based on at least a portion of the accessed supply chain data and the constraints;
decompose the planning horizon into multiple sub-horizons;
optimize the planning problem for each of the multiple sub-horizons; and
generate an optimal supply chain plan for the planning problem, based on the optimization of the multiple sub-horizons.

20. The software of claim 17, wherein the supply chain data is stored in one or more databases by the one or more entities associated with the supply chain network.

21. The software of claim 17, wherein the constraints are stored in one or more databases by the one or more entities associated with the supply chain network.

22. The software of claim 17, wherein the planning problem is stored in one or more databases by the one or more entities associated with the supply chain network.

23. The software of claim 17, wherein decomposing the planning horizon comprises dividing the planning horizon into windows of time based on a time-based decomposition technique.

24. The software of claim 17, wherein the multiple sub-horizons comprise multiple time buckets.

25. The software of claim 17, wherein the one or more entities are entities selected from the group consisting of one or more manufactures, one or more manufacturing plants, one or more distribution centers, one or more work-centers, and one or more customers.

26. The software of claim 17, further operable to:
communicate the optimal supply chain plan to the one or more entities associated with the supply chain network.

27. The software of claim 17, wherein a column generation technique is used to optimize the planning problem for each of the multiple sub-horizons.
